(19) United States
(12) Patent Application Publication
(10) Pub. No.: US 2008/0320282 A1
(43) Pub. Date: Dec. 25, 2008

(54) Method And Systems For Providing Transaction Support For Executable Program Components

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/766,960

(22) Filed: Jun. 22, 2007

(51) Int. Cl. G06F 9/30

(52) U.S. Cl. 712/214; 712/E09.003

(57) ABSTRACT

Methods and systems are described for providing transaction support for executable program components. In one embodiment, transaction information is associated with an instruction included in an executable addressable entity included in an executable program component generated from source code written in a programming language, wherein the transaction information is independent of the source code and the programming language. Further, an access to the instruction is detected for executing by a processor. A transaction operation to perform in association with the executing of the instruction is determined based on the transaction information associated with the instruction. The transaction operation is performed in association with the executing of the instruction, wherein the transaction operation is performed by a program component other than the executable program component including the executable addressable entity.

### RELATED APPLICATIONS

This application is related to U.S. Pat. No. ______, titled “METHOD AND SYSTEMS FOR PROVIDING CONCURRENCY CONTROL FOR ADDRESSABLE ENTITIES”, filed on even date herewith, the entire disclosure of which is here incorporated by reference.

### BACKGROUND

In today's software systems, developing software that involves transactions such as operations using a database can be difficult. Experimentation and testing are typically required to determine correct or optimal transaction boundaries, transaction resources, and transaction policies. Currently, programmers insert transaction related instructions into source code, for example, to start, abort, or commit a transaction. Changing transactional boundaries thus involves a change to software. In other systems, such as in JAVA™ based systems, J2EE transactions can be configured via adding special tags to comment text in JAVA™ source code files and/or configuration files can be provided that allow some ability to configure transaction boundaries. In both cases, the techniques are language specific. Further, the data protected by a transaction is restricted to persistent data that is, typically, data stored in a relational or object oriented database. All data involved in a transaction is from a database accessed during the transaction in a typical scenario. There is no support for a transaction that protects the state of entities included in a program such as a variable.

Today's systems can also use a technology referred to as “transactional memory.” Transactional memory is used for providing concurrency control for a region of memory shared by two or more processes or threads. It is an alternative to lock based concurrency control mechanisms such as semaphores. Like database transactions, support for transactional memory is built into a programming language. Thus, transactional memory is language dependent. and language specific, Transaction memory typically applies to data variables that are shared between two threads or processes.

Accordingly, there exists a need for methods, systems, and computer program products for providing transaction support for executable program components.

### SUMMARY

Methods and systems are described for providing transaction support for executable program components. In one embodiment, transaction information is associated with an instruction included in an executable addressable entity included in an executable program component generated from source code written in a programming language, wherein the transaction information is independent of the source code and the programming language. Further, an access to the instruction is detected for executing by a processor. A transaction operation to perform in association with the executing of the instruction is determined based on the transaction information associated with the instruction. The transaction operation is performed in association with the executing of the instruction, wherein the transaction operation is performed by a program component other than the executable program component including the executable addressable entity.

According to an aspect, a system for providing transaction support for executable program components is disclosed. The system includes means for associating transaction information with an instruction included in an executable addressable entity included in an executable program component generated from source code written in a programming language, wherein the transaction information is independent of the source code and the programming language. The system also includes means for detecting an access to the instruction for executing by a processor. The system further includes means for determining a transaction operation to perform in association with the executing of the instruction based on the transaction information associated with the instruction. The system still further includes means for performing the transaction operation in association with the executing of the instruction, wherein the transaction operation is performed by a program component other than the executable program component including the executable addressable entity.

According to another object, a system for providing transaction support for executable program components is disclosed. The system includes a transaction information manager component configured for associating transaction information with an instruction included in an executable addressable entity included in an executable program component generated from source code written in a programming language, wherein the transaction information is independent of the source code and the programming language. The system also includes an access detector component configured for detecting an access to the instruction for executing by a processor. The system further includes a transaction manager component configured for determining a transaction operation to perform in association with the executing of the instruction based on the transaction information associated with the instruction and configured for performing the transaction operation in association with the executing of the instruction, wherein the transaction operation is performed by a program component other than the executable program component including the executable addressable entity.

According to a further aspect, a computer readable medium including a computer program, executable by a machine, for providing transaction support for executable program components is disclosed. The computer program includes executable instructions for associating transaction information with an instruction included in an executable addressable entity included in an executable program component generated from source code written in a programming language, wherein the transaction information is independent of the source code and the programming language. The computer program also includes instructions for detecting an access to the instruction for executing by a processor. The computer program also includes instructions for determining a transaction operation to perform in association with the executing of the instruction based on the transaction information associated with the instruction. The computer program also includes instructions for performing the transaction operation in association with the executing of the instruction, wherein the transaction operation is performed by a program component other than the executable program component including the executable addressable entity.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for providing transaction support for executable program components according to an embodiment of the subject matter described herein;

FIG. 2 is a block diagram illustrating a system for providing transaction support for executable program components according to another embodiment of the subject matter described herein;

FIG. 3 is a block diagram illustrating a system for providing transaction support for executable program components according to another embodiment of the subject matter described herein;

FIG. 4 is a flow diagram illustrating a method for providing transaction support for executable program components according to an embodiment of the subject matter described herein;

FIG. 5a illustrates an exemplary Extensible Markup Language (XML) document for associating concurrency policies with addressable entities according to another embodiment of the subject matter described herein;

FIG. 5b illustrates an exemplary loadable object file for associating concurrency policies with addressable entities according to another embodiment of the subject matter described herein;

FIG. 6a is a data flow diagram illustrating data flow in a system for providing concurrency control for addressable entities according to another embodiment of the subject matter described herein;

FIG. 6b is a data flow diagram illustrating data flow in a system for providing concurrency control for addressable entities according to another embodiment of the subject matter described herein;

FIG. 6c is a data flow diagram illustrating data flow in a system for providing concurrency control for addressable entities according to another embodiment of the subject matter described herein;

FIG. 6d is a data flow diagram illustrating data flow in a system for providing concurrency control for addressable entities according to another embodiment of the subject matter described herein; and

FIG. 7 is a block diagram illustrating a system for providing transaction support for executable program components according to another embodiment of the subject matter described herein.

### DETAILED DESCRIPTION

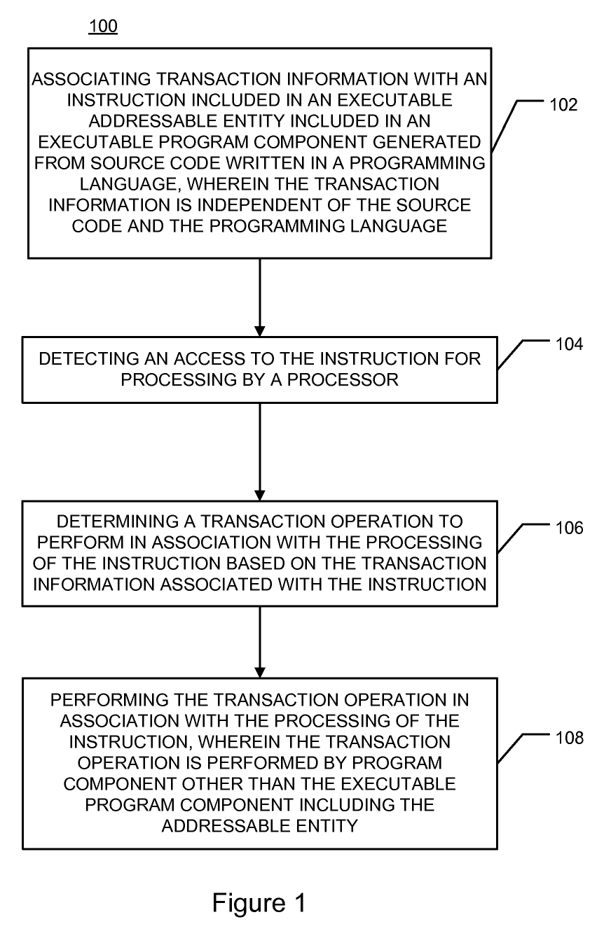

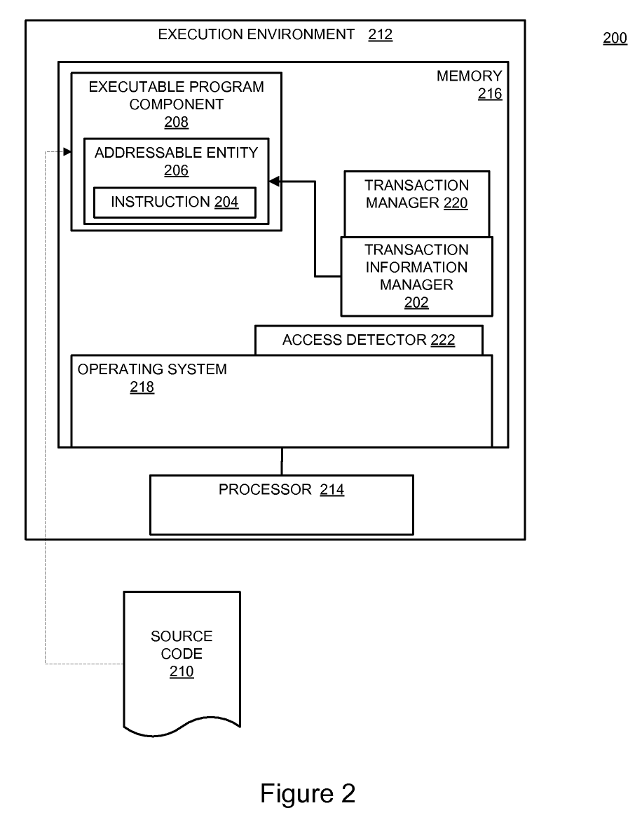

FIG. 1 is a flow diagram illustrating a method for providing transaction support for executable program components according to an exemplary embodiment of the subject matter described herein. A transaction can include a unit of operation of an executable that is treated in a coherent and reliable way independent of other transactions that must be either entirely completed or aborted. FIG. 2 is a block diagram illustrating a system for providing transaction support for executable program components according to another exemplary embodiment of the subject matter described herein. The method illustrated in FIG. 1 can be carried out by, for example, some or all of the components illustrated in the exemplary system of FIG. 2.

With reference to FIG. 1, in block 102 transaction information is associated with an instruction included in an executable addressable entity included in an executable program component generated from source code written in a programming language, wherein the transaction information is independent of the source code and the programming language. Accordingly, a system for providing transaction support for executable program components includes means for associating transaction information with an instruction included in an executable addressable entity included in an executable program component generated from source code written in a programming language, wherein the transaction information is independent of the source code and the programming language. For example, as illustrated in FIG. 2, a transaction information (TI) manager component 202 is configured for associating transaction information with an instruction included in an executable addressable entity included in an executable program component. The executable program component is generated from source code written in a programming language. The transaction information is independent of the source code and the programming language.

For example, an instruction 204 of an executable addressable entity 206 is shown as included in an executable program component 208. The executable program component 208 is generated from a source code representation 210 written in a programming language. The transaction information associated with the instruction 204 is not included in the source code representation 210 and is independent of the programming language.

The association of the transaction information with the instruction 204 can be made directly, for example, by associating an address of a memory location of the instruction 204 with the transaction information in a transaction information record, or by replacing the instruction 204 in a memory location with another instruction for invoking an interceptor component for performing a transaction operation based on the associated transaction information. In another aspect, associating the transaction information with the instruction 204 included in the executable addressable entity 206 includes selecting the transaction information for association with the instruction 204 according to an attribute of the executable addressable entity 206. An attribute of the instruction 204 is any information within an execution environment 212 hosting the instruction 204 that is related to the instruction 204. An attribute can be the virtual or physical memory address of the instruction 204, the instruction itself, an operand of the instruction 204, a data type of an operand of the instruction 204, information associated with a runtime process in which the instruction 204 is accessed, a symbol or name associated with the instruction 204, an attribute of an invoker of the instruction 204, an attribute of a “user” with access privileges to the instruction 204, information associated with the executable addressable entity 206 that includes the instruction 204, and information associated with the executable program component 208 to which the executable addressable entity 206 including the instruction 204 belongs.

The exemplary system 200 can include the execution environment 212 supporting the operation of the executable program component 208. The execution environment 212 can include, for example, a processor 214, a processor addressable memory 216, such as a virtual memory, and an operating system 218. The execution environment 212 can include additional and alternate components and subsystems, such as a network stack (not shown), based on the requirements of a particular device hosting the execution environment 212. The execution environment 212 can be configured to support the processing of executables such as applications and object code libraries.

According to an aspect, the source code representation 210 of the executable program component 208 can be represented in a processor independent source code programming language, wherein a plurality of machine code instructions, each executable by a processor from a specified architecture family, can be generated from the source code representation 210 written in the programming language. For example, the executable program component 208 is an executable representation of the source code representation 210, which can be written in a processor-independent programming language. Some examples of processor-independent programming languages include JAVA™, C, C++, Basic, Perl, and Ruby. A processor independent programming language is a programming language from which a plurality of machine code representations can be generated from a single source written using the programming language, where each respective machine code representation is compatible for execution by a respective processor from a different processor family, such as the INTEL® x86 processor family and the POWERPC® processor family. That is, a machine code representation of a source code representation can be generated that is executable on a processor from a particular processor family and a machine code representation can be generated that is executable on a processor of a second processor family. As such, a source code representation written in a processor-independent programming language can be used to generate an executable representation capable of being run in an execution environment supported by a processor from a family other than the family of the processor 214.

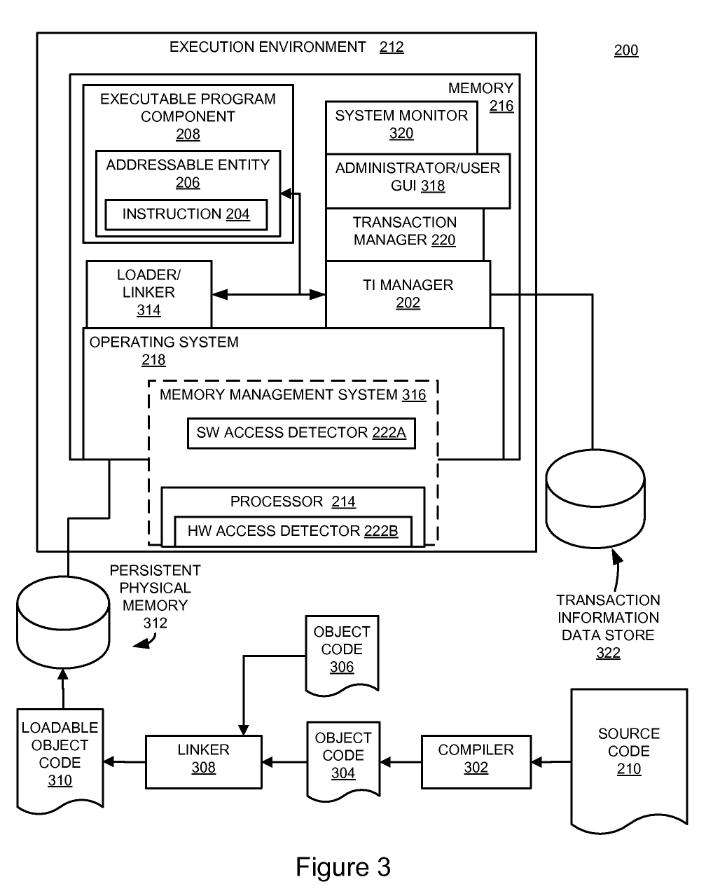

The executable program component 208 including the addressable entity 206 can be generated through a process of compiling the source code 210 using components illustrated in FIG. 3. The executable program component 208 including the addressable entity 206 can be generated using a compiler 302 resulting in an object code representation 304. The object code representation 304 can be linked, if needed, with another object code representation 306 generated from another source code (not shown), using a linker 308 producing a loadable object code representation 310 which can be stored in a persistent physical memory 312 either included in the address space of the memory 216 or outside the address space of the memory 216 as is typically done. Interpreted programming languages are based upon similar principals and are considered within the scope of this document.

The executable program component 208 is created, for example, by a loader/linker 314 interoperating with a memory management system 316 included in the execution environment 212. The loader/linker 314 is configured to load the loadable object code 310 into a memory location in the memory 216 as described above. During the process of loading, the loader/linker 314 and/or the memory management system 316 reserves a memory location that is associated with the addressable entity 206 of the executable program component 208. During loading and/or linking a value associated with the addressable entity 206 is stored in the associated memory location. Thus, each instruction, such as the instruction 204, in an executable addressable entity, such as the executable addressable entity 206, is associated with a memory location.

If the executable program component 208 including the executable addressable entity 206 includes any unresolved references to addressable entities within and/or external to the executable program component 208, a load-time or run-time linking process is performed by a linking component of the loader/linker 314 resolving the unresolved references enabling a runtime process to execute the instructions including the instruction 204 in the executable program component 208 using the processor 214.

According to an aspect, addressable entities including the executable addressable entity 206 in the executable program component 208 are loaded into, and thereby associated with, respective memory locations by a loader/linker that can interoperate with a memory management system 316. Executable entities such as the executable addressable entity 206 include one or more instructions, such as the instruction 204, that are associated with memory locations when the executable addressable entity 206 is loaded into the memory 216.

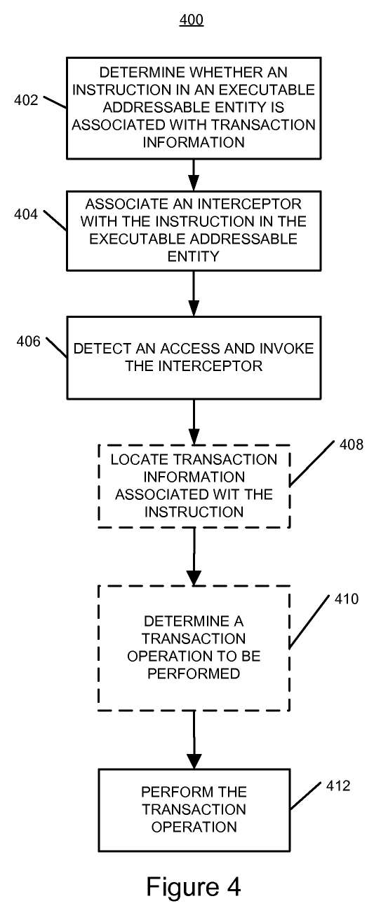

A flow chart 400 in FIG. 4 depicts another exemplary method for providing transaction support for executable program components. In block 402, a determination is made whether an instruction 204 is associated with transaction information. The instruction 204 and its associated executable addressable entity 206 are loaded into the memory 216 by the loader/linker 314 included in the execution environment 212 as depicted in FIG. 3. The executable addressable entity 206 including the instruction 204 in the executable program component 208 loaded into the memory 216 is accessible to the processor 214. The loader/linker 314 uses an address space supported by the processor 214 and the memory 216 where an address from the address space can be used by the processor 214 to locate a memory location of the memory 216.

According to an aspect, the address space of the memory 216 is mapped to a volatile physical memory such as a random access memory (RAM) with any currently unmapped, allocated memory 216 stored in a swap file in a physical persistent memory 312, for example. In another aspect, an address space spans both volatile physical memory and persistent physical memory such a ROM (not shown) and the persistent physical memory 312, such as a hard drive. For example, the address space can be entirely mapped to the persistent physical memory 312 with RAM serving as a cache. U.S. patent application Ser. No. 11/428,273 filed Jun. 30, 2006, entitled “Methods, Systems, And Computer Program Products For Providing A Program Execution Environment,” the entire disclosure of which is here incorporated by reference, describes an operating system hosted language neutral virtual execution environment supporting at least one of a virtual, non-sequential address space and a virtual, structured address space. Further, U.S. patent application Ser. No. 11/428,338 filed Jun. 30, 2006, entitled “Methods, Systems, And Computer Program Products For Providing Access To Addressable Entities Using A Non-Sequential Virtual Address Space,” the entire disclosure of which is here incorporated by reference, describes providing access to addressable entities using at least one of a non-sequential, virtual address space and a structured, virtual address space in a native execution environment. According to an aspect, at least a portion of the persistent physical memory 312 is addressed by the address space of the memory 216 as indicated in the system 200. For example, systems using a structured data storage system (SDSS) based memory management system as described in U.S. patent application Ser. No. 11/428,273 and U.S. patent application Ser. No. 11/428,338 include an address space than can span volatile and persistent physical memory extending processor memory 216 across various types of physical memory.

Transaction information can be provided using a number of language independent techniques. According to an aspect, a declarative language defined for specifying transaction information is used. The declarative language, for example, can be an XML based language specified by a schema where at least a portion of the language is defined for specifying transaction information. In another aspect, a command language is used for specifying transaction information. For example, a command language such as structured query language (SQL) can be used. According to yet another aspect, a user interface, such as an administrator/user graphical user interface 318 can be provided for directing a user in providing transaction information. Transaction information provided by the user is received via the interface component 318 and associated with the instruction 204, for example, based on a condition matching an attribute of the addressable entity 206.

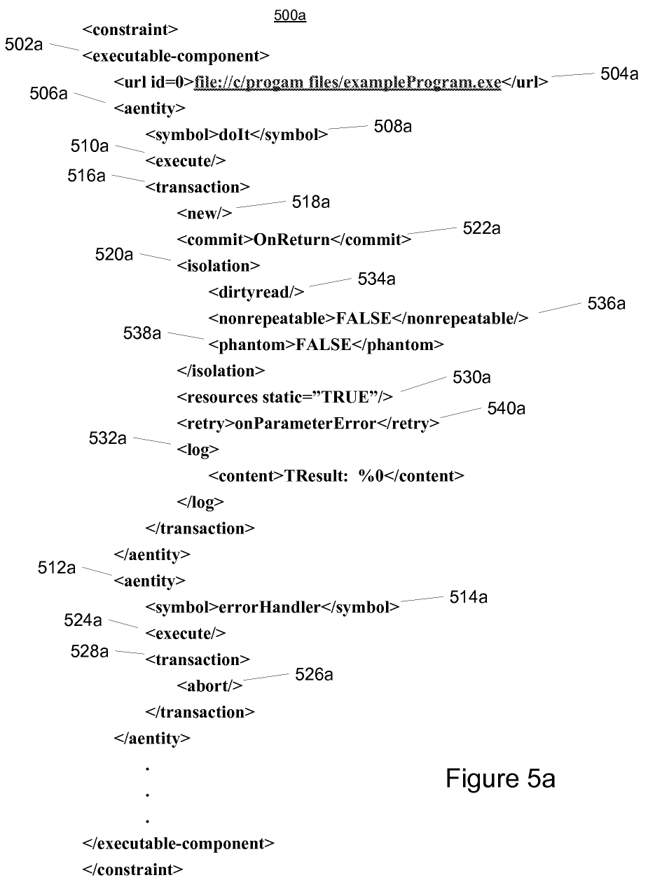

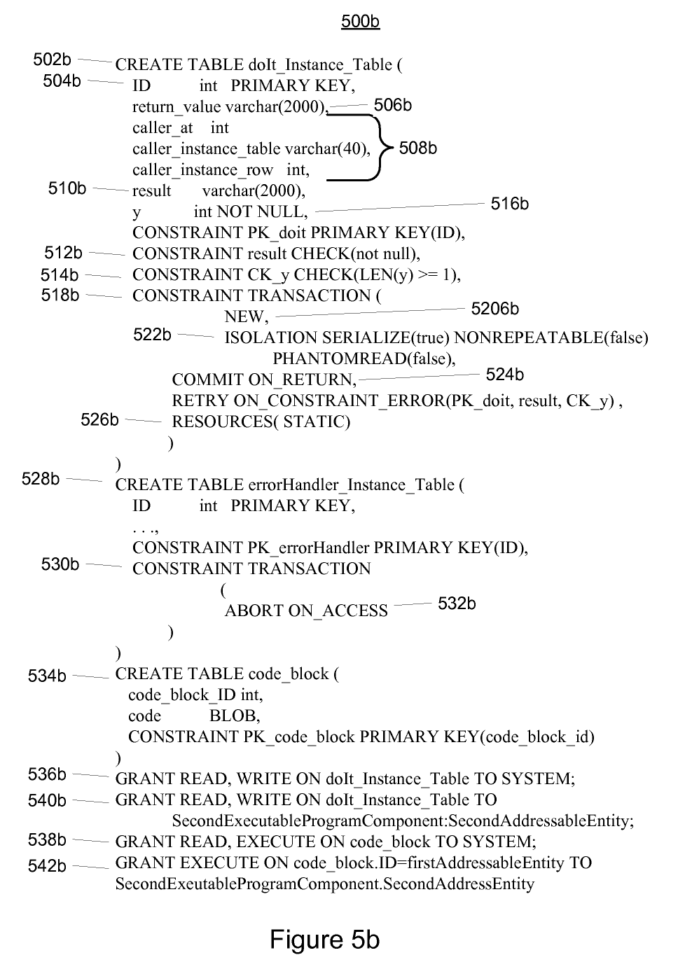

FIG. 5a provides an example of an Extensible Markup Language (XML) document specified by a schema. A portion of the XML markup specified by the schema is defined for specifying transaction information. A transaction information specification, such as depicted in FIG. 5a, can be generated manually by a user. A developer tool, such as a linker, can be configured to generate the transaction information specification based on symbol information and other metadata attributes associated with a representation of the addressable entities included in, for example, the object code 304 and/or the loadable object code 310. A developer tool can require user input for identifying, for example, transaction boundaries and isolation policies based on the symbols for generating a template. A user can edit the generated template using symbol information and/or knowledge of the source code 210 from which the executable program component 208 is generated. Alternatively, a tool such as the compiler 302, linker 308, and/or loader 314 can be configured to map a programming language specific symbol space to a language neutral symbol space defined for identifying program addressable entities in a language neutral manner. Further, symbols in the symbol space of the compiler 302 or interpreter of the programming language used for the source code 210 can be used by a user for ease of use. Programming language specific symbols along with language neutral symbols can be used in generating the transaction information specification and/or a transaction information template.

Returning to the exemplary representation of the transaction information specification in FIG. 5a, a <constraint> XML document 500a is depicted. The <constraint> document 500a can include one or more <executable-component> elements each corresponding to an executable program component, such as, an <executable-component> element 502a corresponding to the executable program component 208. Each <executable-component> element includes an identifier, such as a URI included in a <uri> element, such as a depicted <uri> element 504a that identifies a loadable object code file, such as the loadable object code file 310, including a loadable representation of the executable program component 208. In another aspect, the transaction information includes transaction model information identifying a transactional model for determining a transaction operation to perform in association with the executing of an instruction, such as the instruction 204. An <executable-component> element can include a <transaction-model> element (not shown) allowing for the specification of a particular type of transaction model. For example, the transaction manager component 220 can support a cooperative transaction hierarchy model, a cooperative software engineering environment (SEE) model, a distributed object management (DOM) model, an open public environment model, a “ConTract” model, a split-transaction model, a “Flex” transaction model, an S-transaction model, a multilevel transaction model, and/or a poly-transaction model.

An <executable-component> element can include one or more <aentity> elements. For example, a <aentity> element, specifies attribute conditions for an addressable entity in an executable program component identified by an <uri> element included in an <executable-component> element. An addressable entity can be identified using one or more attribute conditions, referred to as “matching criteria.” Examples of attributes that can be used in conditions specified in matching criteria have been discussed above. According to an aspect, an execution environment condition can be used as a matching criteria. The condition can be detected during the executing of an executable program component, and wherein associating transaction information with an instruction included in an executable addressable entity of the executable program component is based on the detected execution environment condition. For example, the system 200 can include a system monitor component 320 configured for detecting an execution environment condition during the processing of the executable program component 208. The transaction information manager component 202 can be configured for associating the transaction information with an instruction included in an executable addressable entity based on the detected execution environment condition and any additional matching criteria. In another aspect, a matching criterion, such as an execution environment condition, can be detected when an executable program component is not operating. If transaction information associated with the matching criterion is an action not associated with an access to a matching addressable entity, such as changing a transaction model associated with matching addressable entities, the action can be performed.

In an example, an execution environment condition such as processor utilization can be used as an attribute for locating transaction information for associating with the instruction 204 included in the addressable entity 206 when a processor utilization condition included in the matching criteria is met, such as a threshold value for processor utilization of the processor 214. For example, transaction information can be specified that causes a switch from a transaction policy requiring serialized access to a set of transaction resources to a policy that can result in “dirty reads” with respect to one or more of the transaction resources, to improve system performance. Additional examples of matching criteria are provided throughout the document.

In the <constraint> document 500a, an <aentity> element 506a is included with a specification of matching criteria. A <symbol> element can be included for specifying a name/symbol in symbol information generated, for example, during the compile, link, and load process as described above. A <symbol> element 508a specifying “dolt” as a matching symbol criteria is depicted. According to an aspect, wildcard matching is supported for specifying a condition in matching criteria including support for regular expressions and/or their analogs. Further, an <execute> element, such an an <execute/> element 510a, can be used to indicate that a matching entity is an executable addressable entity as is addressable entity 206. A <type> element (not shown) can be supported for general purpose data type specification used in matching criteria. The <execute/> element 510a is a special purpose “type” specification element. Keywords used for content of a <type> element specification are language independent, typically conforming to types supported by the architecture of the target processor, such as the processor 214. Some implementations can support language specific <type> element content as a matching criteria specification. Other examples of attributes that various implementations can support for matching criteria can be identified by one skilled in the art given the description provided in this document.

Service Oriented Architecture Protocol (SOAP), for example, allows addressable entities to be specified for remote procedure calls (RPC) in a language neutral manner using an analogous XML schema. The SOAP schema and namespace can be used in an example of a format for specifying matching criteria and transaction information. Resource definition framework (RDF) can also be used for supporting a schema for generating and processing transaction information supporting both the specification of matching criteria and transaction information. A combination of attributes of an addressable entity including symbol/name, data type information, and runtime process owner, for example, can be specified for identifying addressable entities with matching attributes, associating the matching addressable entities with transaction information.

According to an aspect, <aentity> elements can be nested. The nesting can correspond to a scope for matching an addressable entity with a <aentity> element. Thus, a scope can be specified as a condition in matching criteria. For a programming language or an executable program component supporting only addressable entities having global scope all <aentity> elements appear in the same level as depicted in the <constraint> document 500a as generated by a development tool and/or by a user.

In FIG. 5a, conditions for matching criteria are specified for two sets of transaction information specifications are depicted in the two <aentity> elements, the <aentity> element 506a and a <aentity> element 512a. For example, a <symbol> and/or <type> element can be used for specifying matching criteria for identifying an addressable entity associated with specified transaction information included in an <aentity> element.. The transaction information specification entries in FIG. 5a match addressable entries that are executable as indicated, for example, by the <execute/> element 510a and have an associated symbol of “dolt,” or an associated symbol of “errorHandler,” as specified by the the first <symbol> element 508a and a second <symbol> element 514a, and are at the highest scope level of the executable program component 208 as specified by the nesting of the first <aentity> element 506a and the second <aentity> element 512a. Each set of transaction information specifications is identified by a <transaction> element defined by the corresponding schema for including transaction information specification, such as a <transaction> element 516a included in the first <aentity> element 506a. Content of a <transaction> element is described below.

FIG. 5b illustrates an example of a portion of a loadable object code file for an exemplary SDSS based execution environment, as described in U.S. patent application Ser. No. 11/428,273 and U.S. patent application Ser. No. 11/428,338, providing a transaction information specification. The example shows instructions 500b used by, for example, the loader/linker 314 to create an instance table for a function, such as the “dolt” executable addressable entity 206. A CREATE TABLE instruction block 502b is provided for creating a “dolt_Instance_Table” for holding instance data for instantiations of the “dolt” executable addressable entity 206. As depicted in FIG. 5b, an instance of “dolt” includes a column for an ID 504b serving as a primary key, a return instance variable, “return_value” 506b; three columns 508b identifying the invoking executable addressable entity and a return address, “caller_at”, “caller_instance_table”, and “caller_instance_row”; and an instance variable, “result” 510b. In an example, the “dolt” executable addressable entity 206 accesses a static variable and can invoke one or more other executable addressable entities during its operation that also can access one or more static variables. A number of “CONSTRAINT” commands are illustrated in FIG. 5b that specify constraints on the columns in each “dolt_Instance_Table” row. An SDSS based execution environment in enforcing the specified constraints can provide parameter and data validation data at runtime for the executable program component 208 including the “dolt” executable addressable entity 206. Exemplary constraints depicted in FIG. 5b include a constraint 512b that the instance variable “result” 510b is not null, a constraint 514b that the an instance variable “y” 516b is not null and it is at least one byte in length. A constraint defined for specifying transaction information is depicted as a “CONSTRAINT TRANSACTION” Instruction block 518b A keyword, such as “NEW” 520b, indicates whether and when a transaction can be associated with an instance of the “dolt” executable addressable entity 206. Isolation specifications associated with an ISOLATION keyword 522b are depicted. The ISOLATION keyword 522b and associated syntax and grammar are defined for specifying an isolation policy to be enforced for transaction resources when a transaction is associated with a corresponding instance of the executable addressable entity 206. A COMMIT keyword 524b and associated syntax and grammar are defined for specifying a successful completion point of a transaction. Transaction resources are specified in FIG. 5b by a “RESOURCES” keyword 526b and associated syntax and grammar. Transaction resources must be protected according to transaction specifications such as the specified isolation policy.

A portion of a CREATE TABLE instruction block 528b for creating an instance table for the “errorHandler” executable addressable entity is included in FIG. 5b. The portion includes a transaction information specification using a “CONSTRAINT TRANSACTION” 530b instruction block including a keyword, “ABORT ON_ACCESS” 532b defined for specifying that if an instance of “errorHandler” is accessed under control of a transaction, the transaction is to be aborted and rolled back. In an example, an instance of the “dolt” executable addressable entity 206 invokes an instance of the “errorHandler” executable addressable entity (not shown) when an error condition is detected, thus an access to an instance of the “errorHandler” executable addressable eneity is specified as a boundary of a transaction where the transaction is to be aborted.

Also included in FIG. 5b is a CREATE TABLE instruction block 534b creating a “code_block” table for storing executable instructions of executable addressable entities, such as the “dolt” executable addressable entity 206 and the “errorHandler” executable addressable entity. Records in the “code_block” table include executable instructions for various functions, methods, and other executable addressable entity types.

Alternatively, the transaction information specification can be provided as part of the specification of the “code_block” table 534b rather than included in the specifications of the various executable addressable entity instance tables, such as the CREATE TABLE instruction block 502b and the CREATE TABLE instruction block 528b. Following table creation instructions, additional constraint command language instructions are depicted. A number of GRANT instructions 536b, 538b, 540b, and 542b are illustrated specifying access control policies.

Transaction information specifications can be received through file import, received via a network connection, via a user interface 318, or via any other input techniques. According to an aspect, transaction information specifications, received by the system 300 are stored as transaction information records in a transaction information data store 322. For example, a file including transaction information specification is provided to the system 300, via the administrator/user graphical user interface (GUI) 318, by another executable via a programming interface (not shown), via a file system using a predefined location, and/or using a naming convention. The file data can be provided to the transaction manager component 220 and/or the transaction information manager component 202 for processing and storing as transaction information records in the transaction information data store 322.

Associating transaction information with the instruction 204 included in the executable addressable entity 206 in the executable program component 208 can be accomplished in a variety of ways. According to an aspect, the transaction information manager 202 can be configured to interoperate with at least one of the loader/linker 314 and the memory management system 316 to aid the transaction information manager 202 in associating transaction information with the instruction 204. The transaction information manager 202, according to an aspect, can provide for modifying and/or augmenting the executing of the executable program component 208 using an interceptor design pattern for associating transaction information with the instruction 204. According to another aspect, the transaction information manager 202 provides for marking a memory location of the memory 216 where the location includes the instruction 204 for associating the memory location of the instruction 204 with transaction information.

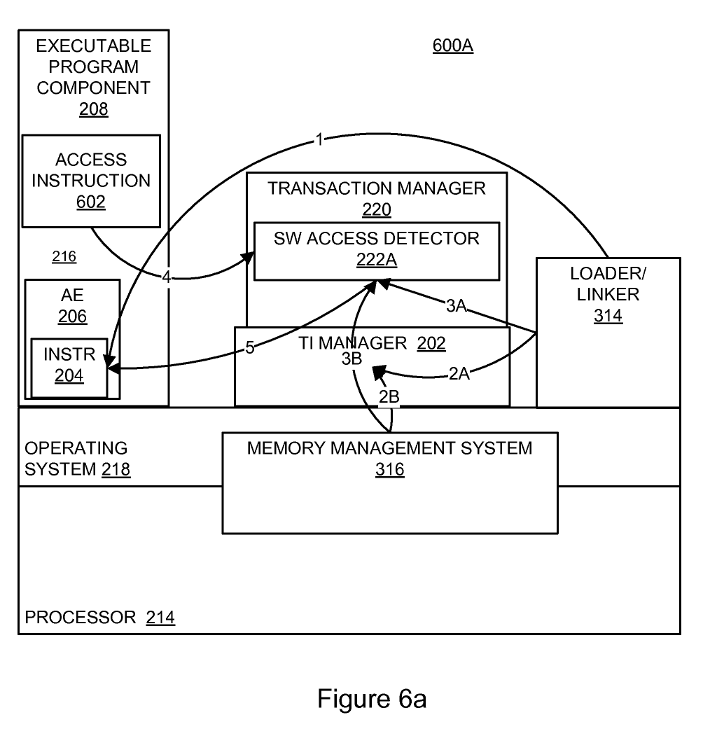

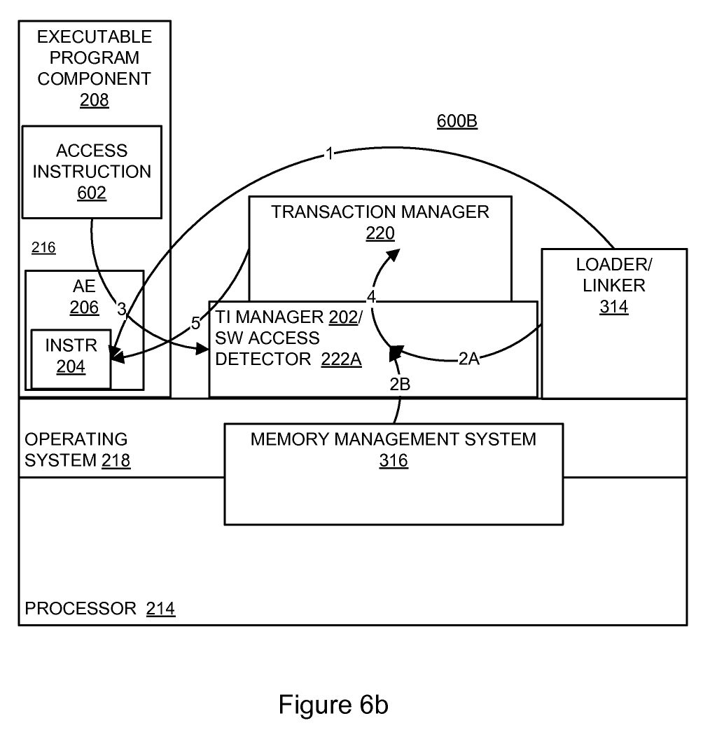

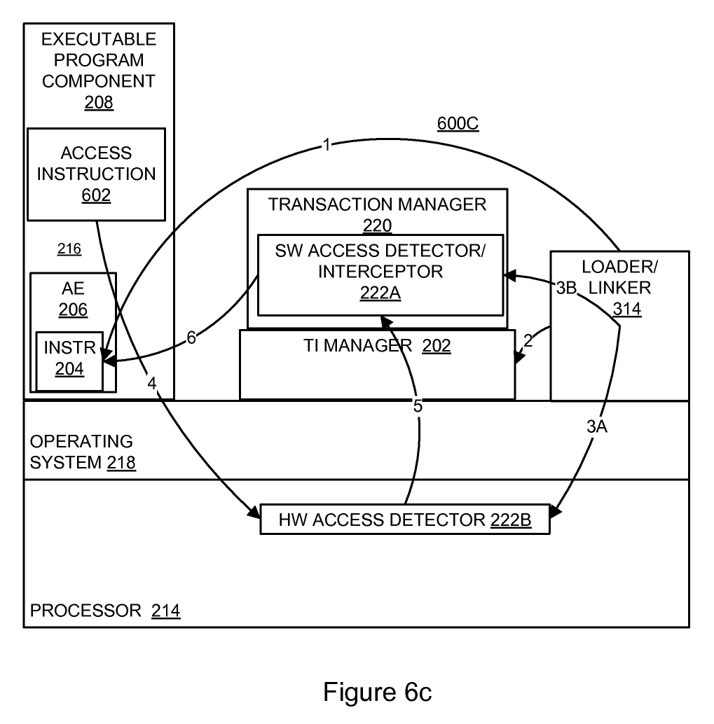

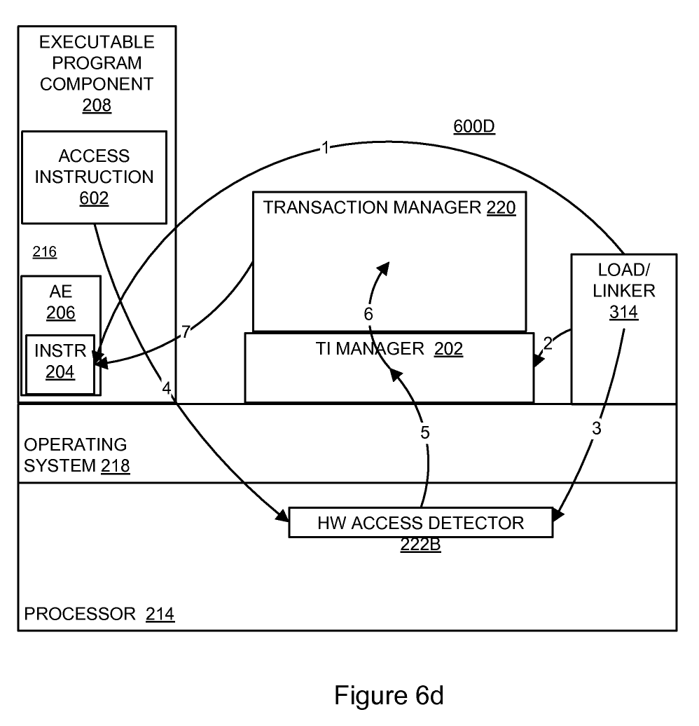

Systems 600a, 600b, 600c, and 600d depicted in FIGS. 6A-D, respectively depict variations of the system 200. Each of the systems 600a-d is configured for carrying out the method 100. Each of the systems 600a-d is configured to load the executable program component 208 into the memory 216, associating a memory location with the instruction 204 as illustrated by each message 1 in each of the systems 600a-d.

For example, in the system 600a in FIG. 6A, the loader/linker 314 is configured to interoperate with the transaction information manager 202 when loading an addressable entity 206 stored in the loadable object code 310 into the memory 216. For example, the loader/linker 314 when loading at least a portion the executable addressable entity 206 including the instruction 204 depicted as a message 1 in FIG. 6A, invokes the transaction information manager 202 depicted as message 2A, providing attribute information associated with instruction 204. The transaction information manager 202 based on the attribute information and/or attribute information available from the execution environment 212 searches the transaction information records in the transaction information data store 322 for a record with matching criteria that matches the attribute information. If a record is not found, the loader/linker 314 continues loading the executable addressable entity 206 including the instruction 204. If a matching record is located, then the transaction information manager 202 can provide a response to the load/linker 220 for associating the instruction 204 with transaction information in the matching transaction information record.

Returning to FIG. 4, in block 404 of the method 400 an interceptor is associated with the instruction 204 based on associated transaction information. For example, in the system 600a the transaction information manager 202 response to the loader/linker 314 causes the loader/linker 314 to provide for an interceptor component depicted as a software access detector component 222A to be invoked in association with an access to the instruction 204 by the processor 214. For example, the instruction 204 can be replaced with a machine code instruction such as a software interrupt instruction where the interceptor component, the software access detector component 222A, is configured to process the software interrupt specified in the instruction. A portion of the execution environment 212 supporting the software interrupt is depicted as the software access detector component 222A in the system 200. The software access detector component 222A is depicted as included in the transaction manager component 220 in the system 600a. The establishing of the interceptor/software access detector component 222A is depicted as a message 3A when performed by the loader/linker 314.

Alternatively, in the system 600a, the memory management system 316 can be configured to mediate memory accesses. For example, SDSS based systems can be configured to mediate access attempts to various addressable entities stored in an SDSS. For example, the memory management system 316 can be configured to create and manage a chain of interceptors associated with an access to an addressable entity such as the executable addressable entity 206 and thus access to a memory location of the instruction 204. Thus the memory management system 316 invokes the transaction information manager 202 for locating transaction information and, optionally, determining an interceptor based on located transaction information as depicted by a message 2B, as opposed to the message 2A as described above. The memory management system 316 can be configured to determine an interceptor based on transaction information located by the transaction information manager 202 or can be configured to receive interceptor information from the transaction information manager 202 The memory manage system 316 can place the interceptor, such as the software access detector component 222A, in an interceptor chain associated with an access to the instruction 204. The interceptor placed in the chain is configured to operate based on the transaction information located by the transaction information manager 202. The establishing of the interceptor by the memory management system 316 is depicted as a message 3B in the system 600a.

Referring to FIG. 6b, in the system 600b, the transaction information manager 202 response to the message 2A described above with respect to the system 600a, causes the loader/linker 314 to configure the transaction information manager 202 to serve as an interceptor component to be invoked in association with an access to the instruction 204 by the processor 214. For example, as described above, in an example, the instruction 204 can be replaced with a machine code instruction such as a software interrupt instruction where the transaction information manager 202 can be configured to be the interrupt handler, thus serving as the interceptor component also known as, the software access detector 222A. The transaction information manager 202 can be configured to process the software interrupt specified in the instruction. Thus, the transaction information manager 202 is configured as an interceptor for associating the instruction 204 with transaction information. The establishing of the transaction information manager 202 as an interceptor is depicted as a message 2A in the system 600b. Alternatively, the memory management system 316 can be configured to modify or augment the executable addressable entity 206 including the instruction 204 to set, for example, a software interrupt and configure the transaction information manager 202 as the handler for the interrupt. The message 2B is depicted to show the memory management system 316 in the role of establishing the transaction information manager 202 as an interceptor of an access of the memory location of the instruction 204 for associating the instruction transaction information.

The system 600b can include the memory management system 316 configured to mediate memory accesses. For example, SDSS based systems can be configured to mediate access attempts to various addressable entities stored in an SDSS as described above. The memory management system 316 can be configured to create and manage a chain of interceptors associated with an access to an addressable entity such as the executable addressable entity 206 and thus access to the instruction 204. The memory management system 316 can establish the transaction information manager 202 as an interceptor, serving as the software access detector component 222A, in an interceptor chain associated with an access to the instruction 204. The interceptor placed in the chain is configured to operate based on the transaction information and is depicted as the message 2B in the system 600b based on an SDSS based memory management system 316.

Referring now to FIG. 6c, in the system 600c, the physical memory supporting the processor memory 216 can be configured to generate one of plurality of hardware interrupts based on a setting of a memory location when accessed by the processor 214. The loader/linker 314 queries the transaction information manager 202 as depicted by the message 2 to determine if an association should be made. The transaction information manager 202 response can cause the loader/linker 314 to set a memory location to generate an interrupt when an access is detected. The particular interrupt or interrupts generated are based on the transaction information located by the transaction information manager 202. The loader/linker 314, for example, can set a bit associated with the location and/or region configured to generate an interrupt when the bit is set. The interrupt in one scenario is associated with an interceptor serving as an interrupt handler where the interceptor is configured to perform a specific transaction operation such as the operation for creating a new transaction. In the scenario, a second interrupt can be associated with a second interceptor configured to enforce an isolation policy specified in the transaction information. The configuring of the hardware interrupt associated with an access to the memory location of the instruction 204 and the configuring of its corresponding interceptor/software access detector component is depicted as a message 3A and a message 3B, respectively, in the system 600c.

Referring now to FIG. 6d, in the system 600d, the physical memory supporting the processor memory 216 is configured to generate a particular hardware interrupt based on an access to a specific physical memory location or region by the processor 214. As indicated the loader/linker 314 queries the transaction information manager 202 as depicted by the message 2 to determine if an association should be made. The transaction information manager 202 response can cause the loader/linker 314 to set a memory location and/or region to generate the particular interrupt when an access is detected. According to an aspect, one interrupt can be used for detecting memory accesses. The transaction information manager 202 is configured to be the interrupt handler/interceptor for all detected accesses according to the aspect. The configuring of the hardware interrupt associated with an access to the memory location of the instruction 204 and the configuring of the transaction information manager 202 as the corresponding interceptor is depicted as a message 3 in the system 600d.

Memory regions, such as pages, that include a memory location of an instruction associated with transaction information can be marked. For example, a request by the loader/linker 314 to the transaction information manager 202 can result in a response from the transaction information manager 202. The response can cause the memory location to be marked indicating that the instruction 204 in the memory location is associated with transaction information. The marking can be performed by any of the loader/linker 314, the transaction information manager 202, and the memory management system 316.

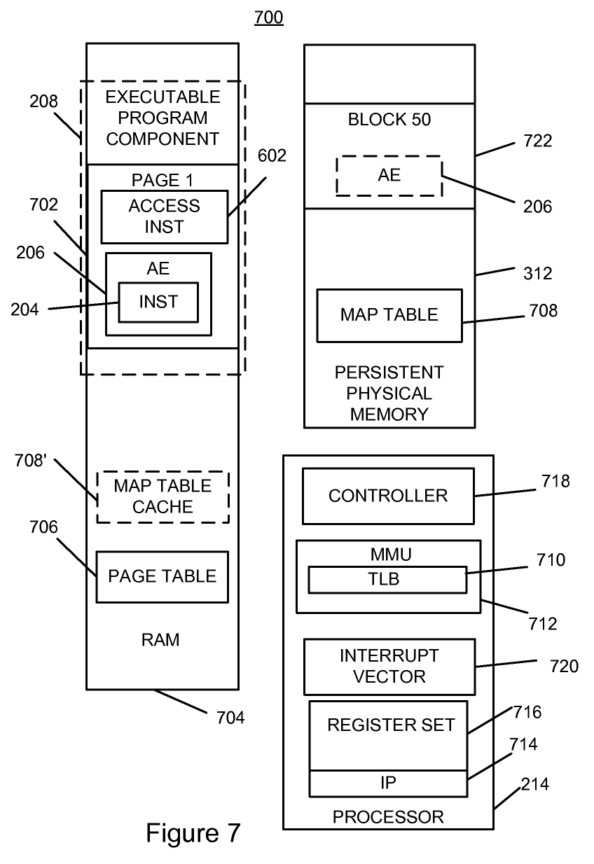

Referring to FIG. 7, a memory management system (portions of which are depicted in the system 700) can store a value in a header portion or other metadata portion of a memory 216 region, such as a page 1 702 as depicted in the system 700 mapped to a region of a volatile physical memory, such as a RAM 704, indicating the memory 216 region, the page 702 in the example, is associated with transaction information or should be checked for an association when an access to the page 702 is detected. Additionally, a page table 706 and a map table 708 along with an optional map table cache 708′, each included in the memory management system 316, can include a record with a field for marking a memory location and/or region corresponding to the record in at least one of the tables 706, 708, and 708′. Additionally, the processor 214 includes a translation lookaside buffer (TLB) 710 included in a memory management unit (MMU) 712 as components of the memory management system 316. The TLB 710 is configured to include a field in a TLB entry for marking the entry indicating an association with transaction information. Thus, the memory management system 316 can use a mark in the TLB 710, the page table 706, the map table 708, the map table cache 708′, and a metadata field in a memory location 216 and/or region such as the page 1 702 including the memory location of the instruction 204. The marking indicates the memory location is associated with transaction information or, at least should be checked for an association. The marking can be performed at load-time by the loader/linker 314 interoperating with the transaction information manager 202, and/or at run-time as described below. The interrupts and interceptors can be configured to be processed any of prior to, during, and after executing of the instruction 204 depending on transaction operations that are required by the associated transaction information as is discussed in more detail below.

Returning to FIG. 1, in block 104 an access to the instruction for executing by a processor is detected. Accordingly, a system for providing transaction support for executable program components includes means for detecting an access to the instruction for executing by a processor. For example, as illustrated in FIG. 2, an access detector component 222 is configured for detecting an access to the instruction for executing by a processor.

Referring again to FIG. 2, an access detector component 222 of the system 200 detects an access to an instruction, such as the instruction 204 associated with transaction information. FIG. 3 illustrates a software access detector component 222A and a hardware access detector component 222B. Some systems provide both a hardware access detector component 222B and a software access detector component 222A while others provide an access detector component 222 using software or only hardware.

In an example, the machine code executed by a runtime process can include an accessing instruction or a plurality of accessing instructions capable of accessing the instruction 204. The accessing instruction can also be generated from a source code, such as the source code 210 or any other source code. The source code includes an accessing source code instruction that when processed and loaded into the memory 216, in one example, references the instruction 204 included in the executable addressable entity 206 using an address from an address space of the memory 216 as an operand or references the executable addressable entity 206 by accessing the executable addressable entity 206 for processing thus causing the instruction 204 to be accessed by the processor 214 as a result.

As illustrated in FIG. 7, the processor 214 can include an instruction pointer (IP) register 714 included in a register set 716. The processor 214 can also include a controller 718 with microcode for interpreting and executing instructions loaded using the IP register 714 and an arithmetic logic unit (ALU) (not shown) for performing arithmetic operations. The IP register 714 is configured for loading an instruction, such as the instruction 204 stored in a memory location of the memory 216 into the processor 214 for executing.

Access to the instruction 204 can be detected by a variety of techniques. In FIG. 4, block 406 of the method 400 includes detecting an access to the instruction 204 and invoking an interceptor. For example, in the systems 200, 300, and 600a-d an access to the instruction 204 is detected by an access detector component 222 where the access detector component includes at least one of the software access detector component 222A using software such as a software interrupt or interceptor configured to be activated in association with the access and the hardware access detector component 222B using hardware such as a hardware interrupt provided by an interrupt vector 720 included in the processor 214 to be activated in association with the access. Block 408 can be performed before block 402, in association with block 402, and/or following block 406, as depicted in FIG. 4.

The detection of the access can indicate that the instruction 204 is associated with a specific set of transaction information, such as when a particular interceptor is invoked as a part of the detection process where the interceptor is associated with the transaction information and is configured, for example, at load time. When this is the case, in the method 400, block 408 can be performed in association with block 402. Alternatively, the detection of the access can indicate that the instruction 204 is associated with transaction information, but the transaction information associated with the instruction 204 is determined at run-time in association with the access detection. In such cases, in the method 400, in block 408 transaction information associated with a detected access to the instruction 204 is executed following block 406 as depicted in FIG. 4. In still other aspects, the detection of the access does not itself indicate that the instruction is associated with transaction information. A determination is made at run-time in association with the detection of the access whether the instruction is associated with transaction information. In such aspects, block 408 is performed after block 406. If no transaction information associated with the access to the instruction 204 is located, the method 400 allows the processor to access the instruction 204 for executing and does not proceed to block 410.

In some aspects, the transaction manager 220 can be configured to interoperate with an access detector 222 in association with an access to the instruction 204. In an aspect, an interceptor of a software access detector 222A can be invoked in association with an access to the instruction 204. The interceptor can be associated with the instruction 204 by at least one of the loader/linker 314 and the memory management system 316 interoperating with the transaction information manager 202 as described above. In another aspect, the memory management system 316 using marked memory regions and/or marked memory management system records in at least one of a region of memory 216, such as a page 702, including the instruction 204, a corresponding page table 706 entry, a corresponding map table 708 or map table cache 708′ entry, and/or a corresponding TLB 710 entry detects access to a memory location that at least should be checked for an association with transaction information in one aspect, and can be associated with transaction information indicated by a mark in another aspect.

Referring now to FIG. 6a, the system 600a includes the loader/linker 314 configured to interoperate with the transaction information manager 202 when loading an addressable entity 206 stored in the loadable object code 310 into the memory 216. As a result of the interoperation, an interceptor component of the depicted software access detector component 222A is provided so that the interceptor is invoked in association with an access to the instruction 204. The invocation of an interceptor is depicted as a message 4 in the system 600a. For example, the instruction 204 can be replaced with a machine code instruction such as a software interrupt instruction where the interceptor component of the software access detector component 222A, is configured to process the software interrupt caused by the executing of the interrupt instruction. When the processor 214 accesses the memory location of the instruction 204, the configured interceptor component of the software access detector component 222A is invoked. Executing of the instruction 204 can occur at any time prior to, during, and/or after processing of the interceptor. Based on the transaction information located by the transaction information manager 202, an interceptor based on the transaction information can be configured as the interrupt handler for the particular interrupt associated with the instruction 204.

In the system 600a, an access instruction 602 is depicted. The access instruction 602, when executed by the processor 214, causes the processor to access a memory location where the accessing instruction 602 is configured to access the instruction 204. The interception of access caused by the executing of access instruction 602 is an exemplary message 4 depicted in the system 600a. Alternatively, the memory management system 316 can be configured to establish an interceptor component of the software access detector component 222 in an interceptor chain associated with an access to the instruction 204 by the processor 214. For example, in an SDSS based system an access to the instruction is detected by an SDSS as described above. The SDSS can invoke the interceptor chain including the interceptor associating the memory location of the instruction 204 with transaction information. Thus, the SDSS detects the access to the instruction 204 for executing by the processor 214. The interceptor placed in the chain can be configured to operate based on the transaction information located by the transaction information manager 202. The establishing of the interceptor by the memory management system 316 is depicted as the message 3B in the system 600a. As just described, the interception of the access attempt by the processor 214 of the instruction 204 caused by the executing of access instruction 602 is depicted as the message 4 in the system 600a.

Referring now to FIG. 6b, the system 600b includes the transaction information manager 202 established as the interceptor of the software access detector component 222A associated with the instruction 204. The association between the interceptor and the memory location of the instruction 204 can be established by the loader/linker 314 and/or the memory management system 316 as described above. Thus, the transaction information manager 202 operating in the role of an interceptor of the software access detector component 222A detects the access to the instruction 204 for executing by the processor 214. In the system 600b, the access instruction 602 is depicted. The access instruction 602 when executed by the processor 214 causes the processor 214 to access the memory location where the accessing instruction 602 is configured to access the instruction 204. The interception by the transaction information manager 202 of access to the memory location caused by the executing of access instruction 602 is depicted as the message 3 in the system 600b. Alternatively, the memory management system 316 can be configured to establish an interceptor for detecting an access of the instruction 204 as a result of the executing of the access instruction 602, for example using an SDSS based memory management system 316 as described above with respect to the system 600a.

Referring now to FIG. 6c, the system 600c includes physical memory for supporting the processor memory 216. The memory can be configured to generate one of a plurality of hardware interrupts based on an access to a specified physical memory location or region by the processor 214 as described above. The system 600c can support multiple hardware interrupts, for example an interrupt vector can be included in the processor 214 to support multiple interrupts. Based on the transaction information located by the transaction information manager 202, an interceptor based on the transaction information is configured as a hardware interrupt handler for the particular interrupt set for the physical memory location to which the memory location and/or region including the instruction 204 is mapped. In the system 600c, the access instruction 602, when executed by the processor 214, causes the processor 214 to access the memory location where the accessing instruction 602 is configured to access the instruction 204. The access causes the configured hardware interrupt to be generated resulting in control being passed to the corresponding interceptor of the software access detector component 222A. The configured interrupt is a part of the hardware access detector component 222B. The interception of the access resulting from executing of the access instruction 602 by the interrupt of the hardware access detector component 222B is depicted as the message 4 in the system 600c. The change of control to the interceptor of the software access detector component 222A resulting from the executing of the access instruction 602 by the processor 214 is depicted as a message 5 in the system 600c.

Referring now to FIG. 6d, the system 600d includes physical memory for supporting the processor memory 216. The memory can be configured to generate a particular hardware interrupt based on an access to a specific physical memory location or region by the processor 214. As described above, the transaction information manager 202 can be configured as the interrupt handler for the particular hardware interrupt. Thus, the transaction information manager 202 serves as the interceptor of the software access detector component 222A for the particular hardware interrupt of the hardware access detector component 222B. The interception of the access resulting from executing of the access instruction 602 by the interrupt of the hardware access detector component 222B is depicted as the message 4 in the system 600c. The change of control to the transaction information manager 202 operating as the interceptor of the software access detector component 222A resulting from the executing of the access instruction 602 by the processor 214 is depicted as a message 5 in the system 600d.

As discussed above, an access to a memory location by the processor 214 is detected. For example, the memory management system 316 can be configured to detect memory 216 accesses by the processor 214. Referring now to FIG. 7, the memory location or region accessed including the instruction 204 is marked using any of the marking systems described above. A determination is made as to whether an entry for the accessed memory location is in the TLB 710 and whether the entry is marked. In the system 700, when the processor 214 attempts to access the memory location of the instruction 204, for example as a result of executing the accessing instruction 602, a lookup in the TLB 710 is performed for locating a physical memory address of the memory location of the instruction 204. If an entry is located in the TLB 710, a determination is made whether the TLB entry is marked. If the TLB entry is not marked the processor 214 is allowed to access the memory location by the memory management system. If the TLB 710 entry is marked, control can be passed to an interceptor for handling as described above. Thus, an access to the instruction 204 is detected.

If there is no entry corresponding to the memory location of the instruction 204 in the TLB 710, then an attempt to locate a page table record corresponding to the accessed memory location is made. For example, if no entry is located in the TLB 710, a page table 706 lookup is performed to determine whether the memory location in the memory 216 is loaded into physical memory. If an entry in the page table 706 is found, a determination is made as to whether the entry is marked. If the page table entry is not marked, the processor 214 is allowed to access the memory location by the memory management system 316. If the entry in the page table 710 is marked, control can be passed to an interceptor as described above. Thus, access to the instruction 204 is detected. Otherwise, the memory management system 316 allows the processor 214 to complete the attempted access.

If the memory management system 316 supports an address space that spans volatile physical memory, such as the RAM 704, and physical persistent memory, as in an SDSS based system, then if there is no entry corresponding to the memory location of the instruction 204 in the page table 706, an attempt to locate the entry corresponding to the memory location in the map table 708 and/or the map table cache 708′ is made. For example, if the memory location is mapped to a physical location in the persistent physical memory 312, such as a block 50 722 including the executable addressable entity 206 and the instruction 204, then a map table 708 and/or a map table cache 708′ lookup locates an entry identifying the physical address of the block 50 722 in the persistent physical memory 312. When an entry in the map table is located, the contents of a region of the physical persistent physical memory 312 including the memory location are loaded into the RAM 704. The page table 706, map table 708, and map table cache 708′ are updated accordingly to indicate the mapping of the memory location in the RAM 704. For example, once the location of a region of memory 216 including the memory location of the instruction 204 included in the executable addressable entity 206 is located in persistent physical memory 312, the memory management system 316 loads the region, block 50 722, into a region of the RAM 704 such as the page 1 702. A determination that the page 702 is marked can be performed by checking the page 702 for a mark or the updated page table entry corresponding to the page 702 can be checked for marking. The page table entry is marked when the map table entry is marked. Thus, access to the instruction 204 is detected.

Returning to FIG. 1, in block 106 a transaction operation to perform in association with the executing of the instruction based on the transaction information associated with the instruction is determined. Accordingly, a system for providing transaction support for executable program components includes means for determining a transaction operation to perform in association with the executing of the instruction based on the transaction information associated with the instruction. For example, as illustrated in FIG. 2, a transaction manager component 220 is configured for determining a transaction operation to perform in association with the executing of the instruction based on the transaction information associated with the instruction.

The transaction manager component 220 determines from the transaction information an operation to perform in association with the executing of the instruction 204 included in the addressable entity 206. According to an aspect, the transaction operation can include at least one of generating a new transaction, committing and terminating a transaction, aborting a transaction and rolling back changes made by the transaction, and invoking a specified event handler. For example, if the executable addressable entity 206 matches the matching criteria of the “dolt” <aentity> element 506a in FIG. 5a, the transaction manager component 220 determines a new transaction should be created based on the <new/> element 518a included in the <transaction> element 516a. The transaction should meet the specification of any other criteria in the transaction information. For example, an <isolation> element 520a specifying isolation policy information included in the <transaction> element 516a specifies transaction isolation policy requirements that the transaction manager component 220 is configured to support for the operation of the associated instruction(s) performed in the context of a transaction. If the memory location access detected is associated with a return from an instance of the “dolt” executable entity 206, the transaction manager component 220 determines from the <aentity> element 506a that the existing transaction should be committed and terminated as specified by a <commit> element 522a. If the memory location detected by the transaction information manager 202 is associated with an access of an instance of the “errorHandler” executable addressable entity, the transaction manager component 220 determines that an abort operation should be performed on the existing transaction as specified in the <aentity> element with matching attributes specified by the <symbol> element 514a and an <execute/> element 524a. The abort operation is transaction information specified by a <abort> element 526a included in a <transaction> element 528a.

In block 410 of the method 400, a transaction operation to perform in association with the detected access is determined. Determining a transaction operation to perform in association with the executing of the instruction 204 can be determined at various times. The time when a determination is performed can affect how tightly or loosely coupled the transaction operation is with the access detector component 222.

Referring now to FIG. 6a, in the system 600a a determination of a transaction operation to perform in association with the executing of the instruction 204 is performed at load/link time by the loader/linker 314 and/or the memory management system 316 interoperating with the transaction information manager 202. That is, block 410 is performed in conjunction with block 402 in this case. For example, as described above, when the “dolt” executable addressable entity 206 in the executable program component 208 is loaded into the memory 216, the transaction information manager 202 uses an attribute associated with an instruction 204 included in the “dolt” executable addressable entity 206 to determine whether a transaction information record in the transaction information data store 322 includes matching criteria based on the attribute. When a match is located, the transaction information in the record can include transaction operation information as described, for example, in FIG. 5a and FIG. 5b. The transaction information and information associated with the detected access including an attribute associated with the instruction 204 is provided to the transaction manager component 220 for determining an operation to be performed in association with an access to an addressable entity being loaded/linked. For example, in FIG. 5a, the transaction information matching an instance of “dolt” executable addressable entity 206 indicates based on the <new/> element 518a that a create transaction operation is to be performed prior to or during the initial executing of an instance of “dolt” executable addressable entity 206. The transaction information also identifies resources specified by a <resources> element 530a that are to be protected during the created transaction and the isolation policy that is to be used specified by the <isolation> element 520a. Thus, the transaction resources are located and necessary setup is performed to enforce the isolation policy. When “dolt” information and the corresponding transaction information from the matching transaction information record is passed to the transaction manger 220, an interceptor of the access detector component 222 can be established that is configured to execute the identified operations when access to the corresponding instruction is detected without requiring the transaction information manager 202 to locate the matching record again.

According to an aspect, a general purpose interceptor of the access detector component 222 can be established at load/link time. For example, the transaction information manager 202 can be established as an interceptor, either based on locating a matching transaction information record or the interceptor can be setup as an interceptor for detected access attempts for an executable addressable entity or an included instruction without determining associated transaction information exists. In another aspect, access information associated with the access to the instruction 204 is identified. A transaction operation to perform in association with the executing of the instruction is determined based on the access information and the transaction information. For example, the access detector component 222 can be configured for identifying access information associated with the access to the instruction 204. The transaction manager component 220 can be configured for determining a transaction operation to perform in association with the executing of the instruction 204 based on the access information and the transaction information. In either case, when the general purpose interceptor is invoked as a result of a detected access, the transaction information manager 202 using an attribute associated with the access information locates a matching transaction information record. If no matching transaction information record is located, executing of the accessed entity is allowed to continue. If a matching transaction information record is located (corresponding to block 408 being performed after block 406), the transaction information along with access information is provided to the transaction manager component 220. The transaction manager component 220 determines a transaction operation to be performed based on the access information and the transaction information performing block 410. For example, the access information can include information identifying the instruction and/or the location of the instruction in an addressable entity. For example, the access information can identify the “dolt” entity 206 and indicate that executing has not yet started. Based on this information and the transaction information corresponding to the <new> 518a, <isolate> 520a, and <resources> 530a elements in FIG. 5a, the transaction manager 220 determines that an operation to create a new transaction should be performed, that the identified resources are to be protected by the transaction, and that a setup operation must be performed to ensure the protected resources are protected according to the isolation policy specified. If the access information indicates the instruction is a return instruction, the transaction manager component 220 based on the access information and the transaction information determines that a commit operation is to be performed based on the <commit> element 522a, a transaction result code log operation is to be performed based on a <log> element 532a, and an operation for freeing unneeded resources associated with the completed transaction is to be performed.

According to an aspect, a loose coupling between a memory location of the instruction 204 and the associated transaction information can be established, at or after load-time. When an access to the instruction 204 is detected, a determination is made by the transaction manager component 220 that a transaction operation is to be performed in association with the access as just described. In association with the access, the association between the instruction 204 and the access detector component 222 for associating the instruction 204 with transaction information can be converted from a loose coupling to a tight coupling. Thus, a second detected access to the instruction 204 does not require the transaction manager component 220 to determine a transaction operation to be performed, since the transaction operation is identified in the tight coupling, for example, by a new interceptor of the access detector component 222A configured to perform the determined transaction operation.

In the system 600a, an interceptor component of the depicted software access detector component 222A can be provided as described above so that the interceptor is invoked in association with an access to the instruction 204. For example, the accessing instruction 602, when executed by the processor 214, causes the processor to attempt an access to a memory location for accessing the instruction 204. Executing of the instruction 204 can occur at any time prior to, during, and/or after processing of the interceptor. Based on the transaction information located by the transaction information manager 202, and attribute information, the transaction manager component 220 determines a transaction operation to be performed in association with an access to the instruction 204 as described above. The transaction manager component 220 can additionally select a preconfigured interceptor and/or generate an interceptor configured to perform the determined transaction operation when invoked a next time without re-determining the transaction operation to be performed.

Alternatively, the transaction manager component 220 can associate the transaction information with an interceptor for processing when an access to the instruction 204 is detected as described above. The interceptor when invoked is configured to use the associated transaction information to determine a transaction operation to be performed without requiring the transaction information to be located a second time by the transaction information manager 202 for associating with the access to the memory location for accessing the instruction 204. Alternatively, the transaction manager component 220 can provide the interceptor with the associated transaction information. The interceptor based on the transaction information determines a transaction operation to be performed in association with a detected access to a memory location for accessing the instruction 204. Once the transaction operation is determined, the interceptor can save information identifying the determined operation, so that when the interceptor is invoked a second time in association with an access to the memory location for accessing the instruction 204, re-determining the transaction operation to be performed is unnecessary.

According to an aspect, the memory management system 316 included in the system 600a can be an SDSS based memory management system 316 that supports an interceptor design pattern for invoking executable addressable entities. The interceptor determined by the transaction manager component 220, as described above, is configured to operate in an interceptor chain associated with an access to the memory location for accessing the instruction 204. The determination can be performed at or before load/link time of the instruction 204 and/or at runtime. Thus, for example, executing of the access instruction 602 by the processor 214 causes the processor 214 to attempt an access to a memory location for accessing the instruction 204. The access is mediated by the memory management system 316. The memory management system 316 invokes an interceptor chain associated with the memory location for processing. The interceptor provided by the transaction manager component 220, as a result, is invoked. The interceptor can be invoked with a transaction operation determined prior to invocation and/or it can interoperate with the transaction information manager 202 and transaction manager component 220 to determine a transaction operation to be performed as a result of the invocation.

Referring again to FIG. 6b, the system 600b, as described above, can include the transaction information manager 202 established as the interceptor of the software access detector component 222A associated with the detection of an access to a memory location for accessing instruction 204. When an access by the processor 214 to the memory location is detected, the transaction information manager 202 is invoked as described earlier. The transaction information manager 202 receives access information including information identifying an attribute associated with the access, such as an address of the memory location. The transaction information manager 202 can use the attribute to locate a transaction information record in the transaction information data store 322 with matching criteria including a condition that matches based on the attribute. Alternatively, the transaction information manager 202 can use the attribute identified in the access information to identify a second attribute for locating a matching transaction information record. For example, a memory map and symbol table associated with the executable program component 208 can be provided. A symbol table can be provided as a result of a compile/link/load process for generating the executable program component 208 from the source code 210 and loading and linking the loadable object code 310 into the memory 216. The loader/linker 314 generates a map including information identifying the memory locations where various addressable entities of the executable program component 208 are loaded, such as the “dolt” executable addressable entity 206 and/or the instruction 204. Further, the loader/linker 314 can be configured to associated memory addresses with at least a portion of the symbols in the symbol table. Thus, given a memory address where a portion of the executable program component 208 is loaded into the memory 216, the transaction information manager 202 can locate a symbol associated with the memory 216 address. As before, the attribute is used to locate a matching transaction information record. In some systems, the transaction information manager 202 is only invoked when the loader/linker 314 interoperating with the transaction information manager 202 at load/link time determines that a matching record exists. In other systems, the determination that a matching record exists occurs when an access by the processor 214 to the memory location for executing the instruction 204 is detected. In either case, the transaction manager component 220 is invoked as depicted by a message 4, to determine a transaction operation to be performed based on the access information and the transaction information as already described.

Referring now to FIG. 6c, the system 600c, as described above, includes the physical memory supporting the processor memory 216 that can be configured for generating a plurality of hardware interrupts based on an access to a specified physical memory location or region by the processor 214 as described above. In the system 600c, multiple hardware interrupts are supported. For example, an interrupt vector can be included in the processor 214 for supporting multiple interrupts. Based on the transaction information located by the transaction information manager 202, an interceptor based on the transaction information is configured as the hardware interrupt handler for the particular interrupt set for the memory location and/or region. In the system 600c, the access instruction 602 is depicted. The access instruction 602, when executed by the processor 214, results in the processor 214 attempting to access the memory location for accessing the instruction 204. The access attempt triggers the configured hardware interrupt to be generated resulting in control being passed to the corresponding interceptor of the software access detector component 222A.

Executing of the instruction 204 can occur at any time prior to, during, and/or after processing of the interceptor. Based on the transaction information located by the transaction information manager 202 and attribute information associated with the access attempt, the transaction manager component 220 determines a transaction operation to be performed in association with an access to the instruction 204 as described above. The transaction manager component 220 of the system 600c can additionally select a preconfigured interceptor and/or generate an interceptor configured to perform the determined transaction operation when invoked without re-determining the transaction operation to be performed. Alternatively, the transaction manager component 220 can associate the transaction information with an interceptor for processing when an access to the instruction 204 is detected. The interceptor when invoked is configured to use the associated transaction information to determine a transaction operation to be performed without requiring the transaction information to be located a second time by the transaction information manager 202 for associating with the access to the memory location for accessing the instruction 204. Alternatively, the transaction manager component 220 can provide the interceptor with the associated transaction information. When invoked, the interceptor based on the transaction information determines a transaction operation to be performed in association with a detected access to a memory location for accessing the instruction 204. Once the transaction operation is determined, the interceptor saves information identifying the determined operation, so that when the interceptor is invoked a second time in association with an access to the memory location for accessing the instruction 204, re-determining the transaction operation to be performed is unnecessary. The saved transaction operation can be used.

Referring again to FIG. 6d, the system 600d, as described above, includes physical memory supporting the processor memory 216 that can be configured to generate a hardware interrupt based on an access to a physical memory location or region by the processor 214. As described above the transaction information manager 202 can be configured as the interrupt handler for the particular hardware interrupt. Thus, the transaction information manager 202 serves as the interceptor of the software access detector component 222A for the particular hardware interrupt of the hardware access detector component 222B. When an access by the processor 214 to the memory location is detected, the transaction information manager 202 is invoked as the interrupt handler of the hardware interrupt. Since the hardware interrupt is not associated with any particular transaction operation of information, the transaction information manager 202 uses access information including information identifying an attribute associated with the access received in the invocation process to locate a matching transaction information record in the transaction information data store 322. Alternatively, the transaction information manager 202 can use the attribute identified in the access information to identify a second attribute for locating a matching transaction information record as described earlier in an example using a memory map and a symbol table.

Once an access to memory has been detected, a determination is made as to whether transaction information is associated with the detected memory access. For example, the transaction information manager 202 attempts to locate a matching transaction information record for the instruction 204 included in the “dolt” executable addressable entity. Based on the symbol “dolt,” the information that the instruction 204 is executable, and information from, for example, a symbol table indicating “dolt” has top level scope in the executable program component 208 a matching transaction information record is located by the transaction information manager 202 in the transaction information data store 322. If transaction information is located, the transaction information is passed to the transaction manager 220 as indicated by a message 6. The transaction manager 220 determines a transaction operation to perform in association with the access of the instruction 204.

In FIG. 5a, each <aentity> element 502a and 512a, can correspond to a transaction information record in the transaction information data store 322. Thus, there is a transaction information record corresponding to the <aentity> element 506a for instances of the “dolt” executable addressable entity 206 and a transaction information record corresponding to the <aentity> element 512a for instances of an “errorHandler” Executable addressable entity A matching executable addressable entity 206, “dolt,” has a global scope within its including executable program component 208. This scope information can be used as a condition to be matched in the matching criteria of the corresponding transaction information record. The matching criteria thus includes a condition for matching the “dolt” symbol, a condition that a matching addressable entity is an executable addressable entity, and a condition that the access is for an addressable entity with top level scope in the executable program component 208.

The <transaction> element 516a is included for specifying transaction information to be associated with matching accesses as described above. The <new/> element 518a is provided for specifying that a new transaction must be created for each instance of the “dolt” executable addressable entity 206. The specification can indicate the transaction create operation is to be performed when an access to an initial instruction 204 included in the “dolt” executable addressable entity 206 is detected. The initial instruction can be determined based on a policy as described above. Thus, if the instruction 204 is the “initial” instruction in “dolt” as determined, the transaction manager component 220 determines that a transaction operation for creating a new transaction is to be performed in association with an access to the initial instruction of the “dolt” executable addressable entity 206.

For example, in a system supporting a schema associated with FIG. 5a, a rule/policy associated with the schema can specify that when a <transaction> element is associated with an executable addressable entity without a specification of any particular instruction, an initial instruction can be associated with initial transaction information. A new transaction is to be created even if the runtime process is operating within an existing transaction causing a nesting of transactions. In addition to <new>, a <supports> element can be provided for specifying that an associated executable addressable entity can be processed within an existing transaction, but a transaction is not required. This allows the transaction manager component 220 to determine that a transaction operation for creating a transaction is not required, but an operation allowing the associated executable addressable entity to participate in an existing transaction is to be performed when an existing transaction is detected. A <requires> element can be provided to indicate that an executable addressable entity can run within an exiting transaction, but, if there is no existing transaction associated with the runtime process accessing the instruction 204, for example, in an instance of executable addressable entity 206, then an operation for creating a new transaction should be performed prior to or during the initialization of the “dolt” instance. Those familiar with transaction systems will understand that elements described are exemplary, and that other elements can be used instead of and/or in addition to the examples provided based on the transaction system used.

The <commit> element 522a as described above specifies when a transaction has completed and should be committed. In the <aentity> element 506a for a “dolt” executable addressable entity 206, the transaction created for the “dolt” instance is to be committed when a return from the “dolt” entity is detected. Thus, the transaction manager component 220 determines that a commit operation is to be performed in association with an access to any instruction that performs a normal return from the executable addressable entity 206.

The <isolation> element 520a as described specifies isolation policy information. For example, a transaction can allow “dirty reads” as can be indicated by a <dirtyread> element 534a, or it can require serialized access to transaction resources as indicated by a <serialize> element (not shown). A dirty read allows a reader to see modifications made but not committed by a transaction in which the read is not being performed. “Dirty reads” can improve performance by avoiding lock contention between a runtime process reading from an addressable entity and a runtime process that writes to the same addressable entity. A “dirty read,” can cause problems because the data read might not be committed meaning the reader may be working with incorrect data. In the absence of a specification for a transaction attribute, a default can be specified. For example, <serialize> can be the default. According to an aspect, some or all transaction information attributes can have associated default values including a <transaction> element and its analogs.

The transaction information illustrated in FIG. 5a further indicates that for an instance of the “dolt” executable addressable eneity 206, non-repeatable reads are not allowed as specified by a <nonrepeatable> element 536a and phantom reads are not allowed as specified by a <phantom> element 538a. If non-repeatable reads are allowed, it is possible that a runtime process can read from a particular addressable entity a number of times without writing to the addressable entity, and not get the same value on every read. If phantom reads are allowed, it is possible that when a runtime process operates, for example, on a row from an addressable entity that is a table, another runtime process can be adding or deleting rows from the same table leading to inconsistencies This information allows the transaction manager component 220 to determine operations to be performed in association with transaction setup and configuration for enforcing the specified isolation policies with respect to the transaction resources identified in a <resources> element 530a.

Transaction information can include information not required or directly related to support for transactions. For example, FIG. 5a includes a <log> element 532a for specifying logging requirements to be provided for by the transaction manager component 220 for an associated transaction. The <log> element 522a associated with an instance of the “dolt” executable addressable entity 206 indicates a message logging the result code indicated by the % 0 symbol is to be logged in a string with the prefix, “TResult:”. In the example, “% 0” is defined to indicate a transaction operation result code. Thus, the transaction manager component 220 determines that a message logging a transaction result code is to be performed when a transaction operation is performed in a association with a matching addressable entity.

A <retry> element 540a indicates that if an error associated with an addressable entity serving as an input and/or output parameter of, for example, a function or method, is detected during the unit of operation under control of transaction, the transaction manager component 220 is to roll-back the transaction and present an error message to a user including the parameter error information. Via the presentation to the user, the transaction manager component 220 can receive an indication to abort the unit of operation or can receive new parameter data and as indicated retry the failed operation.

The second <aentity> entry 512a matches addressable entities that are executable and have an associated symbol, “errorHandler.” In the example, instances of the “dolt” executable addressable entity 206 invoke an instance of the “errorHandler” entity when executing of “dolt” is not successful. A developer can use knowledge of this relationship to abort a transaction created for a “dolt” instance when runtime process executing “dolt” accesses an “errorHandler” instance. This is depicted as the <abort> element 526a included within a <transaction> element within the <aentity> element 512a of “errorHandler.” The transaction manager component 220 determines that a detected access to an instruction invoking an instance of “errorHandler” requires an operation for aborting a transaction if an associated transaction exists.

FIG. 5b illustrates analogous transaction information to the command language transaction information discussed above, such as a database-backed SDSS based system using a SQL compatible database. For example, the constraint including transaction information depicted as the “CONSTRAINT TRANSACTION” instruction block 518b. A keyword, such as “NEW” 520b allows the transaction manager component 220 to determine whether and when a transaction can be associated with an instance of the executable addressable entity 206 and operations to be performed for supporting the isolation specifications with respect to the transaction resources also specified, as discussed earlier. The operation of the transaction manager 220 in determining a transaction operation to perform in association with an access to a memory location of the instruction 204 is analogous to that described with respect to FIG. 5a.

Returning to FIG. 1, in block 108 the transaction operation is performed in association with the executing of the instruction, wherein the transaction operation is performed by a program component other than the executable program component including the executable addressable entity. Accordingly, a system for providing transaction support for executable program components includes means for performing the transaction operation in association with the executing of the instruction, wherein the transaction operation is performed by a program component other than the executable program component including the executable addressable entity. For example, as illustrated in FIG. 2, a transaction manager component 220 is configured for performing the transaction operation in association with the executing of the instruction, wherein the transaction operation is performed by a program component other than the executable program component including the executable addressable entity.

Referring again to FIG. 4, at block 412 the transaction operation is performed. For example, the transaction manager component 220 performs or provides for performing each of the determined transaction operations associated with each of the corresponding instructions in the “dolt” 206 and “errorHandler” executable addressable entities as illustrated in FIG. 5a. For example, when instruction 204 is accessed via an invocation of the “dolt” executable addressable entity 206 by the first access instruction 602 operating in a first runtime process, the transaction manager component 220 creates a new transaction having attributes based on the “dolt” transaction information record in the transaction information data store 322 created based on the “dolt” <aentity> element 506a in FIG. 5a. The operation is not indicated in the source code representation 210 from which the instruction 204 was generated. Upon creation of the transaction, the “dolt” executable addressable entity 206 including the accessed instruction 204 is executed in an associated runtime process within the context of the new transaction.

When an access to each of two instances of the “dolt” executable addressable entity 206 is detected, for example, in two runtime processes, the two transactions can operate concurrently. When operated concurrently the transaction manager component 220 ensures the required isolation policy as indicated in the transaction information is enforced. According to the <isolation> element 520a in FIG. 5a, the transaction manager component 220 allows “dirty reads” during the operation of the transactions, but does not allow phantom reads or non-repeatable reads. Further, according to the <retry> element 540a specification in FIG. 5a, the transaction manger performs the determined operation, 220 based on a determination associating a detection of an invalid parameter while processing in the context of an associated transaction. In the illustrated example, a retry operation is the determined operation performed in response to detecting the invalid parameter. The transaction manager component 220 can receive an indication to abort the transaction associated with the runtime process in which the parameter condition was detected. The transaction manager component 220, upon receiving the abort indication, rolls back the operation and restores the resources specified in the resources portion of the associated transaction information based on the <resources> element 530a to their state at the time of the creation of the associated transaction. Alternatively, via a user interface, the transaction manager component 220 can receive new parameter data and an indication to retry the failed portion of the operation. In this case, the transaction manager component 220 restores the unit of operation to its state prior to the detection of the parameter condition and restarts the unit of operation from that point using the received parameter data.

If, during the processing of either runtime process under the control of each corresponding transaction, an access to the “errorHandler” executable addressable entity instruction is detected, then the corresponding transaction can be rolled-back as determined by the transaction manager component 220 and aborted according to the <abort> element 526a.

If the executing of the “dolt” executable addressable entity 206 returns normally, then the transaction is committed and destroyed by the transaction manager component 220 as indicated by the <commit> element 522a. An instruction indicating a return from “dolt” can be detected at load time by the loader 314, according to an aspect. For example, if the processor 214 supports a “return” instruction defined to return from a function or subroutine invocation, the “return” instruction can be detected and associated with transaction information based on the <aentity> element 506a. In another example, if the processor 214 supports a stack based execution model, operations changing a processor register defined to reference a base of a stack frame can be detected at runtime. Such instructions indicating a return from an invocation of an executable addressable entity can be associated with transaction information at runtime using matching criteria in a transaction information record and an attribute of the instruction 204. In an SDSS based execution environment, returns can be mediated and thus detected by the SDSS memory manager 316. For example, the deleting of a “dolt” instance record can indicate a return and/or a table can be maintained for tracking a call path within a process.

The transaction operation can be performed in association with a detected access to a memory location of the instruction 204 at the time the access is detected as indicated above, or the transaction operation can be performed before any access is detected. For example, in FIG. 5b the isolation policy for access to instances of the “dolt” executable addressable entity 206 requires serialized access to the identified transaction resources with non-repeatable reads and phantom reads not allowed. In an SDSS based system, an SDSS can perform at least a portion of the transaction operations to be performed for enforcing the specified isolation policy prior to a detected access. The isolation policy 522b portion of the constraint 518b can be at least partially enforced by allowing only one row to exist in the “dolt_Instance_Table” 502b at any give time, thus ensuring complete isolation of the processing of the transaction resources 526b as far as processing of an instance of the “dolt” executable addressable entity 206 is concerned. The transaction resources are identified by the “RESOURCES” 526b keyword as static variables in the executable program component 208 that can be accessed during an operation of an instance of the “dolt” executable addressable entity 206. According to an aspect, analysis of the possible execution paths and use of a corresponding symbol table including type information can be used to identify the particular transaction resources. With this information, the transaction manager component 220 can determine a more efficient access policy for enforcing the transaction isolation constraints 522b than forcing serialized access to the “dolt” executable addressable entity 206. Thus, the transaction operations are determined at or before the creation of the loadable object code 310, and are performed at load-time as well as at time of access according to the commands depicted in the portion of the loadable object file 500b.

Similarly, for the “errorHandler” executable addressable entity, the transaction operation for aborting a transaction can be determined during or before creation of the loadable object code and associated with an instance of the “errorHandler” executable addressable entity. The abort operation can be performed when an access to a memory location associated with an invocation of an instance of “errorHandler” is detected at run-time. The transaction information specified using the “CONSTRAINT TRANSACTION” 530b condition includes a specification, “ABORT ON-ACCESS” 532b indicating that if an instance of the “errorHandler” executable addressable entity is accessed under control of a transaction, the transaction is to be aborted and rolled back. Also included in FIG. 5b is the CREATE TABLE instruction block 534b for creating a “code_block” table for storing executable instructions of executable addressable entities, such as instructions for the “dolt” executable addressable entity and the “errorHandler” executable addressable entity. Records in the “code_block” table 534b include executable instructions for various functions, methods, and other executable addressable entity types. Alternatively, transaction information specifications can be provided as part of the specification of the “code_block” table rather than included in the specifications of the various executable addressable entity instance tables.

Following the CREATE TABLE instruction block 534b, additional constraint commands are depicted. The first GRANT command 536b grants read and write access to dolt_Instance_Table 502b instances to the SYSTEM process ID allowing the execution environment 212 to use only the single row instance created at the time the executable program component 208 is loaded into the memory 216. The third GRANT command 538b gives SYSTEM execute access to the executable “code_block” table allowing the machine and/or virtual byte code in each row of the code_block table 534b to be accessed and executed by the processor 214. The second GRANT command 540b allows an executable addressable entity, SecondAddressableEntity (not shown), in a second executable program component, SecondExecutableProgramComponent, to read and write data from and to records of the dolt_Instance_Table 502b. This allows a runtime process executing the machine code of the second executable program component to access the executable addressable entity 206, “dolt.” The fourth GRANT command 542b gives executable addressable entity, SecondAddressableEntity, in the second executable program component, SecondExecutableProgramComponent, execute access to a record in the code_block table 534b corresponding to the executable addressable entity associated with the “dolt” executable addressable entity 206. The second GRANT command 540b and the fourth GRANT command 542b allow the secondAddressableEntity to invoke the “dolt” executable addressable entity 206 for execution by the processor 214.

In addition to using SQL commands to provide and enforce transaction information, additional columns and tables can be used for supporting additional features. For example, an executable addressable entity table can include a column for storing a reference to transaction information. This technique does not require the matching of attributes as described above. Access to the instruction 204 by the processor performed in association with the performing of a determined transaction operation by the transaction manager component 220 is depicted as a message 5 in the system 600a-b, a message 6 in the system 600c, a message 7 in the system 600d.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g) or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing transaction support for executable program components, the method comprising:
associating transaction information with an instruction included in an executable addressable entity included in an executable program component generated from source code written in a programming language, wherein the transaction information is independent of the source code and the programming language;
detecting an access to the instruction for executing by a processor;
determining a transaction operation to perform in association with the executing of the instruction based on the transaction information associated with the instruction; and
performing the transaction operation in association with the executing of the instruction, wherein the transaction operation is performed by a program component other than the executable program component including the executable addressable entity.

2. The method of claim 1 wherein associating transaction information with an instruction included in an executable addressable entity includes associating transaction information with a memory location associated with the instruction included in the executable addressable entity.

3. The method of claim 1 wherein the source code of the executable program component is in a processor independent programming language, wherein a plurality of machine code instructions, each executable by a specified processor from a different processor architecture family, can be generated from the source code.

4. The method of claim 1 wherein associating the transaction information with an instruction included in an executable addressable entity includes selecting the transaction information for association with the instruction according to an attribute of the executable addressable entity.

5. The method of claim 1 wherein the transaction information includes model information identifying a transactional model for determining a transaction operation to perform in association with the executing of the instruction.

6. The method of claim 1 including detecting an execution environment condition during the processing of the executable program component, and wherein associating the transaction information with the instruction included in the executable addressable entity is based on the detected execution environment condition.

7. The method of claim 1 wherein detecting an access to the instruction includes identifying access information associated with the access to the instruction, and
wherein determining a transaction operation to perform in association with the executing of the instruction is based on the access information and the transaction information.

8. The method of claim 1 wherein the transaction operation includes at least one of generating a new transaction, committing and terminating a transaction, aborting a transaction and rolling back changes made by the transaction, and invoking a specified event handler.

9. The method of claim 1 wherein the transaction operation is performed at least one of before the executing of the instruction, during the executing of the instruction and after the executing of the instruction.

10. A system for providing transaction support for executable program components, the system comprising:
means for associating transaction information with an instruction included in an executable addressable entity included in an executable program component generated from source code written in a programming language, wherein the transaction information is independent of the source code and the programming language;
means for detecting an access to the instruction for executing by a processor;
means for determining a transaction operation to perform in association with the executing of the instruction based on the transaction information associated with the instruction; and
means for performing the transaction operation in association with the executing of the instruction, wherein the transaction operation is performed by a program component other than the executable program component including the executable addressable entity.

11. A system for providing transaction support for executable program components, the system comprising:
a transaction information manager component configured for associating transaction information with an instruction included in an executable addressable entity included in an executable program component generated from source code written in a programming language, wherein the transaction information is independent of the source code and the programming language;
a access detector component configured for detecting an access to the instruction for executing by a processor; and
a transaction manager component configured for determining a transaction operation to perform in association with the executing of the instruction based on the transaction information associated with the instruction and configured for performing the transaction operation in association with the executing of the instruction, wherein the transaction operation is performed by a program component other than the executable program component including the executable addressable entity.

12. The system of claim 11 wherein the transaction information manager component is configured for associating transaction information with a memory location associated with the instruction included in the executable addressable entity.

13. The system of claim 12 including a memory management system component configured for detecting an access to the memory location associated with the instruction included in the executable addressable entity

14. The system of claim 11 wherein the source code of the executable program component is in a processor independent programming language, wherein a plurality of machine code instructions, each executable by a specified processor from a different processor architecture family, can be generated from the source code.

15. The system of claim 11 wherein the transaction information manager component is configured for selecting the transaction information for association with the instruction according to an attribute of the executable addressable entity.

16. The system of claim 11 wherein the transaction information includes model information identifying a transactional model, wherein the transaction manager component is configured for determining a transaction operation to perform in association with the executing of the instruction according to the transactional model.

17. The system of claim 11 including a system monitor component configured for detecting an execution environment condition during the processing of the executable program component, and wherein the transaction information manager component is configured for associating the transaction information with the instruction included in the executable addressable entity is based on the detected execution environment condition.

18. The system of claim 11 wherein the access detector component is configured for identifying access information associated with the access to the instruction, and
wherein the transaction manager component is configured for determining a transaction operation to perform in association with the executing of the instruction is based on the access information and the transaction information.

19. The system of claim 11 wherein the transaction manager component is configured for performing from at least one of generating a new transaction, committing and terminating a transaction, aborting a transaction and rolling back changes made by the transaction, and invoking a specified event handler.

20. The system of claim 11 wherein the transaction manager component is configured for performing the transaction operation at least one of before the executing of the instruction, during the executing of the instruction and after the executing of the instruction.

21. A computer readable medium including a computer program, executable by a machine, for providing transaction support for executable program components, the computer program comprising executable instructions for:
associating transaction information with an instruction included in an executable addressable entity included in an executable program component generated from source code written in a programming language, wherein the transaction information is independent of the source code and the programming language;
detecting an access to the instruction for executing by a processor;
determining a transaction operation to perform in association with the executing of the instruction based on the transaction information associated with the instruction; and
performing the transaction operation in association with the executing of the instruction, wherein the transaction operation is performed by a program component other than the executable program component including the executable addressable entity.
